(19) United States
(12) Patent Application Publication
(10) Pub. No.: US 2023/0158535 A1
(43) Pub. Date: May 25, 2023

(54) SHOWER HEAD HANGER

(71) Applicant: Yongqiang Yan, Xiamen (CN)

(72) Inventors: Changzheng Ni, Xiamen (CN); Pingqing Zhang, Xiamen (CN); Haihua Su, Xiamen (CN); Lengjie Huang, Quanzhou (CN)

(21) Appl. No.: 17/669,174

(22) Filed: Feb. 10, 2022

(30) Foreign Application Priority Data
Nov. 19, 2021 (CN) 202122853552.5

(51) Int. Cl. B05B 15/62; E03C 1/04

(52) U.S. Cl. CPC B05B 15/62; E03C 1/0408

(57) ABSTRACT

The present utility model provides a shower head hanger, including a hanging seat and a connection rod connected with an end of the hanging seat. A shower head is hung on the other end of the hanging seat, and the connection rod is disposed on a wall to enable the shower head to be disposed on the wall along with the hanging seat. A first magnetic attracting portion is disposed at an end of the hanging seat close to the shower head, a second magnetic attracting portion corresponding to the first attracting portion is disposed inside the shower head, and the first magnetic attracting portion and the second magnetic attracting portion are magnetically attracted with each other such that the shower head is hung on the hanging seat. The present utility model features conveniences and simple operations.

### CROSS-REFERENCE TO RELATED APPLICATION

The present application is based on, and claims priority from, Chinese application number CN202122853552.5, filed Nov. 19, 2021, the disclosure of which is hereby incorporated by reference herein in its entirety.

### TECHNICAL FIELD

The present utility model relates to the technical field of bathroom products, and in particular to a shower head hanger.

### BACKGROUND

In existing common shower head holders or hangers, a shower head is typically connected with a shower head hose and inserted into a shower head holder through a flared joint of the shower head hose. The shower head holder is then fixedly locked on a wall. In this case, the shower head is hung on the wall only via the shower head hose. Further, the connection stability may only be guaranteed through position alignment. Therefore, typical shower head holders or hangers are extremely inconvenient for users.

### SUMMARY

In order to solve the above technical problems, the present utility model provides a shower head hanger.

To achieve the above object, the present utility model adopts the following technical solution.

Provided is a shower head hanger, including a hanging seat and a connection rod connected with one end of the hanging seat. A shower head is hung on the other end of the hanging seat, and the connection rod is disposed on a wall to enable the shower head to be disposed on the wall along with the hanging seat. A first magnetic attracting portion is disposed at an end of the hanging seat close to the shower head, a second magnetic attracting portion corresponding to the first attracting portion is disposed inside the shower head, and the first magnetic attracting portion and the second magnetic attracting portion are magnetically attracted with each other such that the shower head is hung on the hanging seat.

Preferably, the first magnetic attracting portion and the second magnetic attracting portion have different magnetic poles.

Preferably, a magnet is disposed inside the first magnetic attracting portion, an iron piece is disposed inside the second magnetic attracting portion, and the magnet and the iron piece are attracted with each other such that the first magnetic attracting portion and the second magnetic attracting portion are attracted with each other.

Preferably, an iron piece is disposed inside the first magnetic attracting portion, a magnet is disposed inside the second magnetic attracting portion, and the iron piece and the magnet are attracted with each other such that the first magnetic attracting portion and the second magnetic attracting portion are attracted with each other.

Preferably, a first magnetic attracting cavity is disposed at an end of the hanging seat close to the shower head, a second magnetic attracting cavity is disposed at a side of a body of the shower head away from a water spraying cover of the shower head, and the first magnetic attracting portion and the second magnetic attracting portion are received in the first magnetic attracting cavity and the second magnetic attracting cavity respectively such that the first magnetic attracting portion and the second magnetic attracting portion are magnetically attracted with each other.

Preferably, surfaces of mutually-attached sides of the first magnetic attracting portion and the second magnetic attracting portion are provided with a rubber portion, the rubber portions fully cover the surfaces of the first magnetic attracting portion and the second magnetic attracting portion respectively or at least one through hole is opened in the rubber portions such that the first magnetic attracting portion and the second magnetic attracting portion are attracted with each other through exposure of the through holes.

Preferably, a ball-shaped cavity is disposed at an end of the hanging seat away from the first magnetic attracting portion, a ball body is disposed at an end of the connection rod close to the hanging seat, and the ball body is received in the ball-shaped cavity such that the hanging seat is capable of swinging arbitrarily around the ball body.

Preferably, the connection rod has a water flowing channel, an end of the connection rod close to the hanging seat is connected with a connection piece, a water flowing opening in communication with the water flowing channel is opened on the connection piece, the ball body is disposed at an end of the connection piece close to the hanging seat, and the ball body and the water flowing channel are isolated apart.

Preferably, a first connection position is disposed at an end of the connection rod away from the ball body, a second connection position is convexly disposed at an end of the cover body close to the connection rod, and the first connection position and the second connection position are fixedly connected such that the connection rod and the cover body are connected.

Preferably, the shower head hanger further includes a cover body, where the cover body is sleeved on the connection rod and connected to a wall through the connection rod, or fixedly connected with the connection rod and bonded to the wall.

The present utility model has the following beneficial effects:
1) The first magnetic attracting portion and the second magnetic attracting portion each having different magnetic poles are disposed on the hanging seat and the shower head respectively such that the shower head can be quickly hung on the hanging seat through mutual attraction of the two magnetic attracting portions, resulting in convenience and simple operation.
2) The rubber portions are disposed on the outer surfaces of the first magnetic attracting portion and the second magnetic attracting portion and at least one through hole is opened on the rubber portions such that the magnetic forces enabling the first magnetic attracting portion and the second magnetic attracting portion to be attracted to each other are increased through exposure via the through holes. The first magnetic attracting portion and the second magnetic attracting portion may also be prevented from falling out of the first magnetic attracting cavity and the second magnetic attracting cavity due to unbalanced forces from each side.
3) The ball body is disposed on the connection rod connected with the hanging seat and the ball-shaped cavity is disposed on the hanging seat, such that the ball body is capable of swinging freely and arbitrarily in the ball-shaped cavity to enable the shower head to swing arbitrarily along the hanging seat.
4) The water flowing channel and the water flowing opening are disposed on the connection rod such that the connection rod can supply water and is fixedly connected to the hanging seat simultaneously, thereby reducing the number of parts and thus lowering costs.
5) The cover body connected with the connection rod is disposed as a plane such that the cover body may be directly bonded to a wall through adhesive, thereby enabling simple and convenient mounting.

### BRIEF DESCRIPTIONS OF THE DRAWINGS

The accompanying drawings described herein are used to provide further understanding of the present utility model and constitute a part of the present utility model. The exemplary embodiments of the present utility model and their descriptions are used to explain the present utility model rather than constitute any improper limitation to the present utility model.

FIG. 1 is axonometric diagram 1 of a shower head hanger according to a first embodiment of the present utility model.

FIG. 2 is exploded view 1 of a shower head hanger according to a first embodiment of the present utility model.

FIG. 3 is axonometric diagram 2 of a shower head hanger according to a first embodiment of the present utility model.

FIG. 4 is exploded view 2 of a shower head hanger according to a first embodiment of the present utility model.

FIG. 5 is a sectional view of a shower head hanger according to a first embodiment of the present utility model.

FIG. 6 is axonometric diagram 1 of a shower head hanger according to a second embodiment of the present utility model.

FIG. 7 is exploded view 1 of a shower head hanger according to a second embodiment of the present utility model.

FIG. 8 is axonometric diagram 2 of a shower head hanger according to a second embodiment of the present utility model.

FIG. 9 is exploded view 2 of a shower head hanger according to a second embodiment of the present utility model.

FIG. 10 is a sectional view of a shower head hanger according to a second embodiment of the present utility model.

FIG. 11 is a partial axonometric diagram of a shower head hanger according to the present utility model.

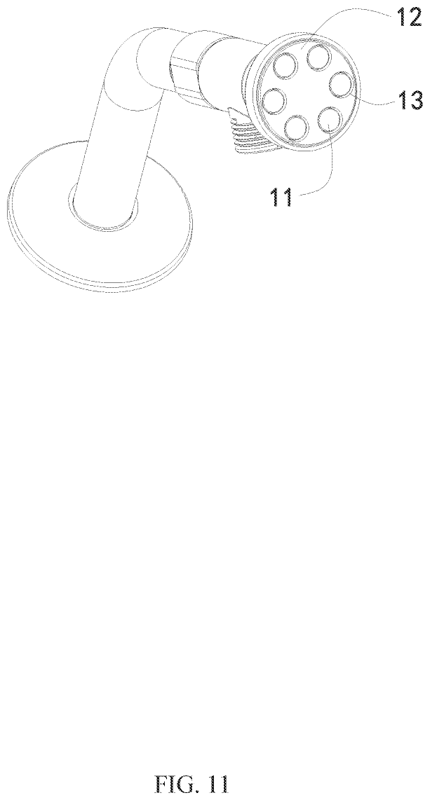

Numerals of the drawings are described below:

1 hanging seat, 11 first magnetic attracting portion, 12 rubber portion, 13 through hole,

2 shower head 21 second magnetic attracting portion,

3 connection rod, 31 connection piece, 32 water flowing opening, 33 ball body,

4 cover body.

### DETAILED DESCRIPTIONS OF EMBODIMENTS

In order to make the technical problems, technical solutions and beneficial effects of the present utility model clearer and more understandable, the present utility model will be further described below in combination with the accompanying drawings and the specific embodiments. It should be understood that the specific embodiments described herein are used only to explain the present utility model rather than limit the present utility model.

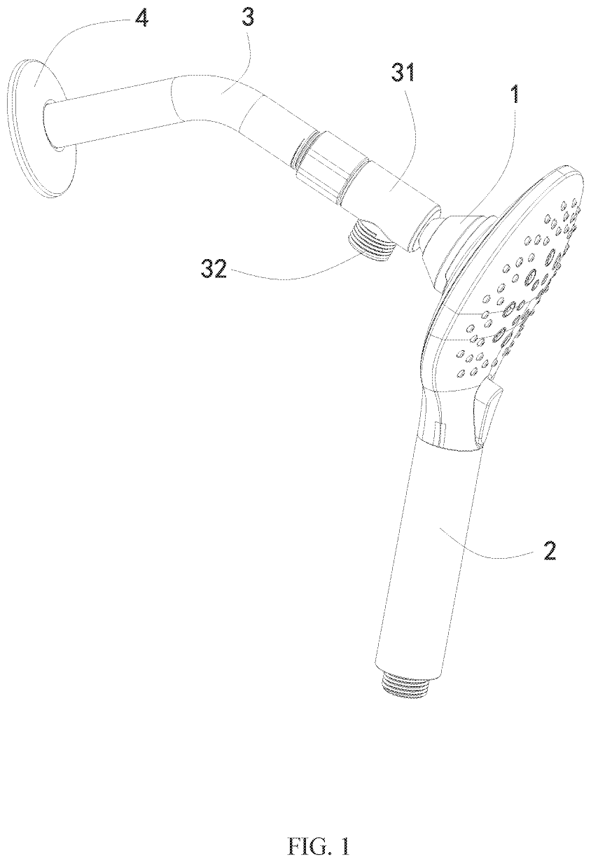

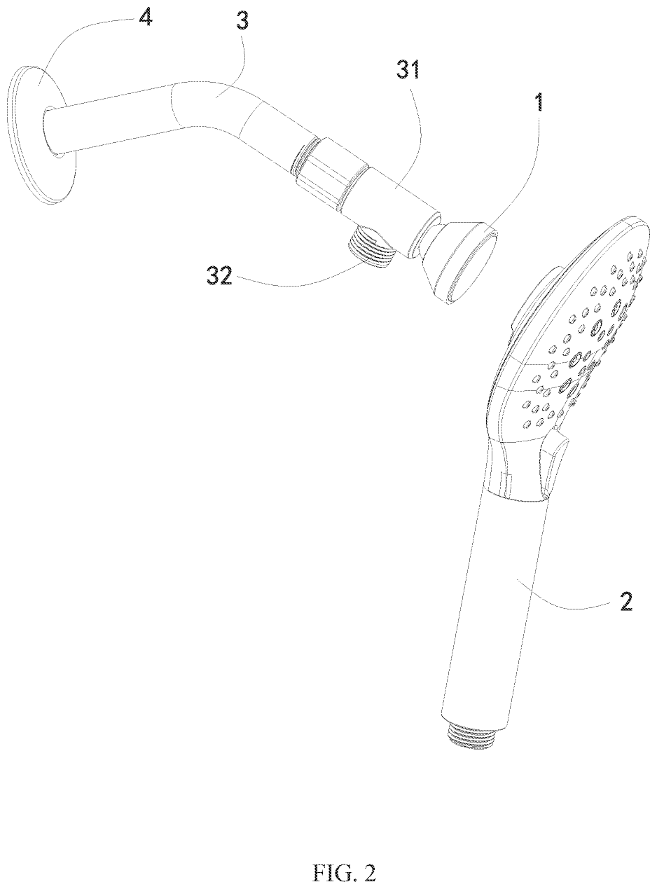

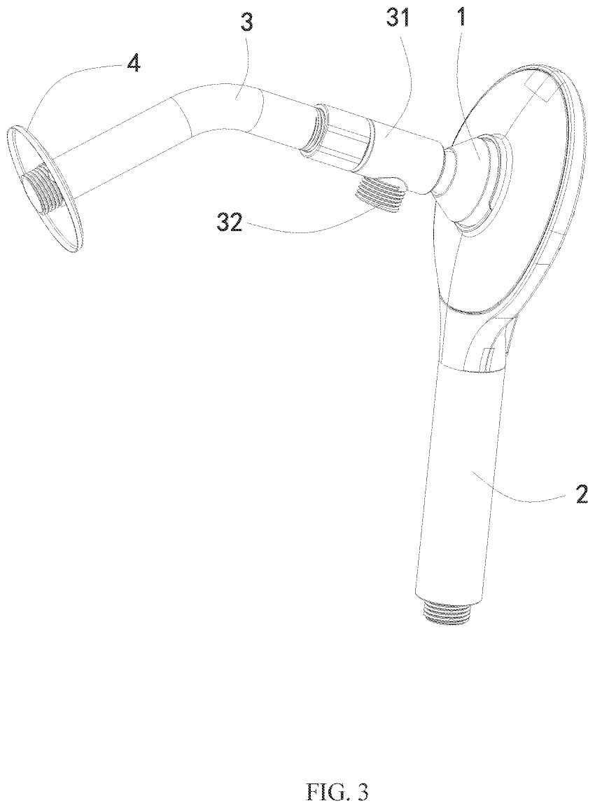

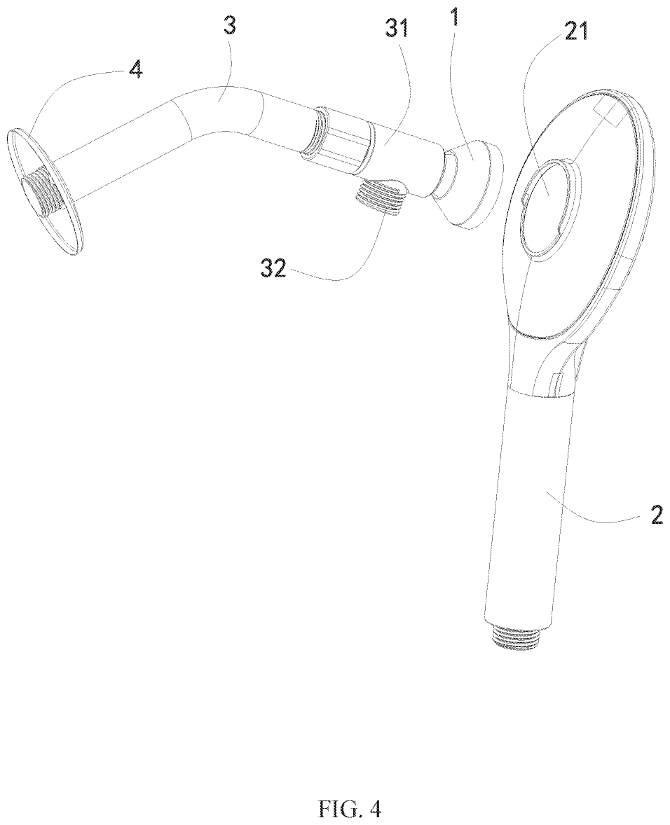

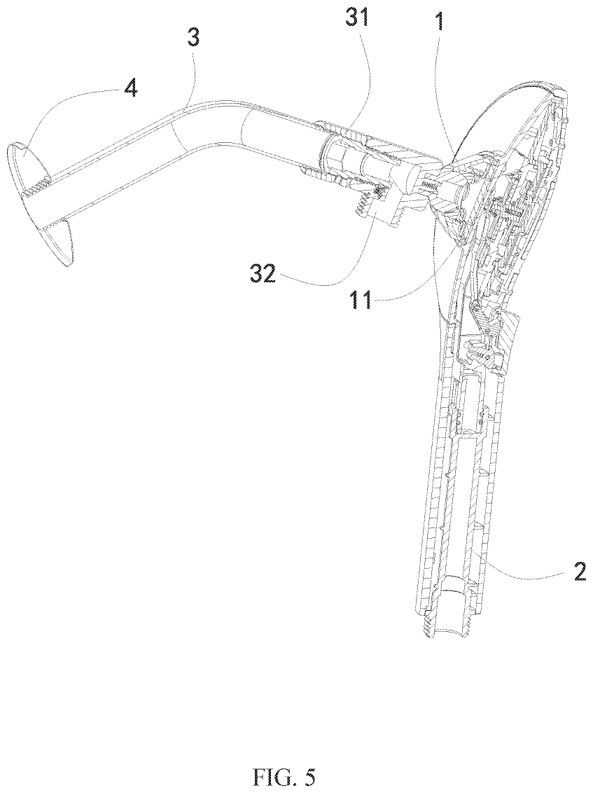

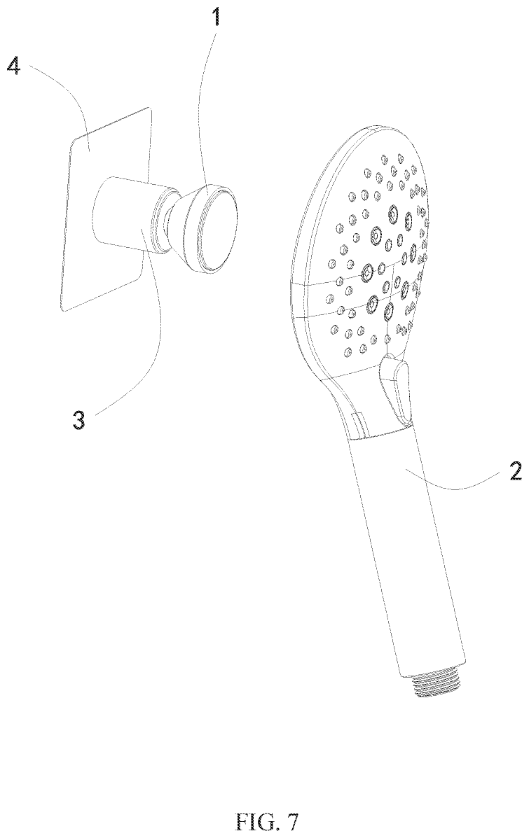

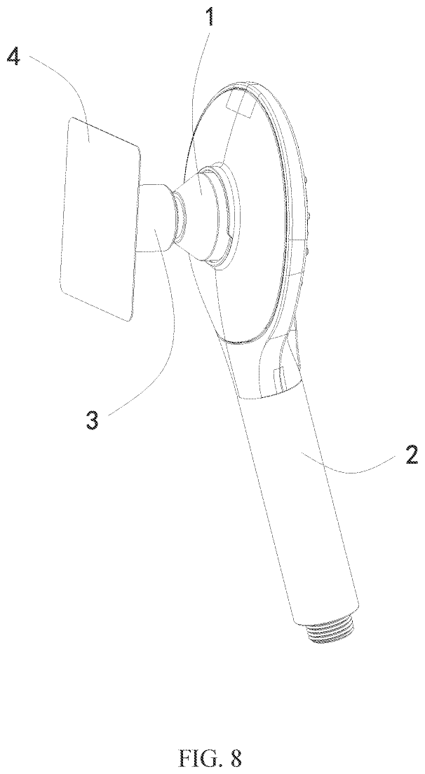

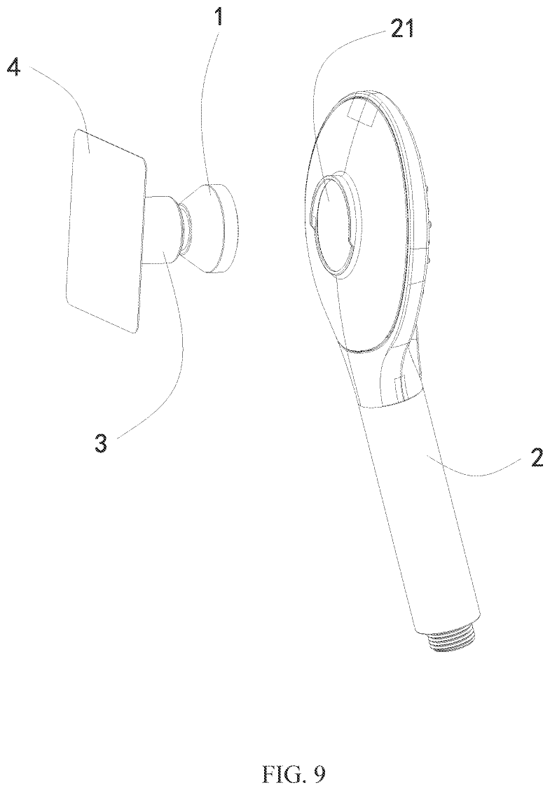

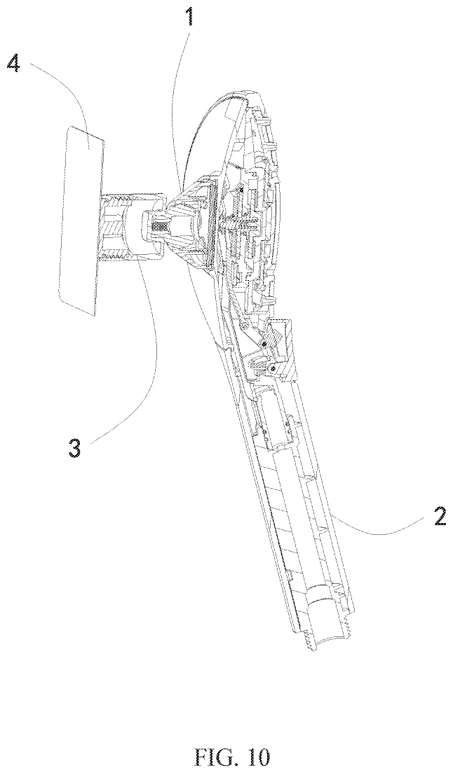

As shown in FIGS. 1-10, a preferred embodiment of the present utility model provides a shower head hanger, including a hanging seat 1, a connection rod 3 connected with an end of the hanging seat 1 and a cover body 4 disposed at the other end of the connection rod 3. A shower head 2 is disposed at the other end of the hanging seat 1, the connection rod 3 is connected to a wall, and the cover body 4 is connected with the connection rod 3 and covers a defect on the wall.

In existing common shower head holders, the shower head 2 is typically connected via a hose of the shower head 2 and then inserted into a shower head holder through a flared joint of the shower head hose. The shower head holder is then fixedly locked on a wall. In this case, the shower head 2 can be hung on the wall only through the shower head hose. In the present utility model, a first magnetic attracting portion 11 is disposed at an end of the hanging seat 1 close to the shower head 2, a second magnetic attracting portion 21 corresponding to the first attracting portion 11 is disposed inside the shower head 2, the first magnetic attracting portion 11 and the second magnetic attracting portion 21 are magnetically attracted with each other to enable the shower head 2 to be directly hung on the hanging seat 2, and the hanging seat 1 is hung on a wall through the connection rod 3. In this way, the shower head 2 can be hung on the wall.

The first magnetic attracting portion 11 and the second magnetic attracting portion 21 have different magnetic poles such that the first magnetic attracting portion 11 and the second magnetic attracting portion 21 are attracted with each other.

A magnet is disposed inside the first magnetic attracting portion 11, an iron piece is disposed inside the second magnetic attracting portion 21, and the magnet and the iron piece are attracted with each other. In this case, the first magnetic attracting portion 11 and the second magnetic attracting portion 21 are attracted with each other to enable the shower head 2 to be magnetically attracted to the hanging seat 1.

An iron piece is disposed inside the first magnetic attracting portion 11, a magnet is disposed inside the second magnetic attracting portion 21, and the iron piece and the magnet are attracted with each other. In this case, the first magnetic attracting portion 11 and the second magnetic attracting portion 21 are attracted with each other to enable the shower head 2 to be magnetically attracted to the hanging seat 1.

The second magnetic attracting portion 21 is disposed at a side of a body of the shower head 2 away from a water spraying cover of the shower head 2. The body of the shower head 2 has a second magnetic attracting cavity in which the second magnetic attracting portion 21 is received. The hanging seat 1 has a first magnetic attracting cavity in which the first magnetic attracting portion 11 is received. When the first magnetic attracting portion 11 and the second magnetic attracting portion 21 are magnets having different magnetic poles, the magnets may be wrapped with one layer of plastic piece. In this case, the magnetisms of the magnets need to be strong enough to ensure the first magnetic attracting portion 11 and the second magnetic attracting portion 21 are attracted with each other. When the second magnetic attracting portion 21 and the first magnetic attracting portion 11 are a magnet and an iron piece, respectively, the iron piece is not externally wrapped with plastic but zinc-plated to ensure a magnetic force between the second magnetic attracting portion 21 and the first magnetic attracting portion 11. In other embodiments, a rubber portion 12 is disposed on surfaces of mutually-attached sides of the first magnetic attracting portion 11 and the second magnetic attracting portion 21. The rubber portions 12 may fully cover the surfaces of the first magnetic attracting portion 11 and the second magnetic attracting portion 21 or one or more through holes 13 are opened on the rubber portions 12 to increase a magnetic force between the first magnetic attracting portion 11 and the second magnetic attracting portion 21 through exposure of the through holes 13. Further, the rubber portions 12 may protect the surfaces of the first magnetic attracting portion 11 and the second magnetic attracting portion 21 and may also prevent the first magnetic attracting portion 11 and the second magnetic attracting portion 21 from falling out of the first magnetic attracting cavity and the second magnetic attracting cavity due to unbalanced forces of each side.

The shape of the second magnetic attracting portion 21 may be a circular shape, a square shape or an irregular shape. The shape of the first magnetic attracting portion 11 is consistent with the shape of the second magnetic attracting portion 21. Further, the shape of the second magnetic attracting portion 21 is consistent with the shape of the body of the shower head 2. Thus, the shapes of the shower head 2 and the hanging seat 1 match and are aesthetically pleasing.

A ball-shaped cavity is disposed at an end of the hanging seat opposite the first magnetic attracting portion 11, and a ball body 33 is disposed at an end of the connection rod 3 adjacent to the hanging seat 1. The ball body 33 is received in the ball-shaped cavity such that the hanging seat 1 can swing arbitrarily around the ball body 33 and thus the shower head 2 can swing arbitrarily along the hanging seat 1.

With reference to FIGS. 1-5, in the first embodiment, the connection rod 3 includes a water flowing channel, an end of the connection rod 3 close to the hanging seat 1 is connected with a connection piece 31, a water flowing opening 32 in communication with the water flowing channel is opened on the connection piece 31, the ball body 33 is disposed at an end of the connection piece 31 close to the hanging seat 1, and the ball body 33 and the water flowing channel are isolated. A connection portion is disposed at an end of the connection rod 3 away from the hanging seat 1, and the connection portion is fixedly communicated with a water supply pipe in a wall. The cover body 4 has a through hole and hence is sleeved on the connection rod 3 through the through hole to cover an unaesthetic part between the connection portion and the wall. The water flowing opening 32 is in communication with the shower head 2 through a water flowing hose, such that water can flow from the water supply pipe in the wall to the water flowing channel and then from the water flowing opening 32 to the water flowing hose and then to the shower head 2.

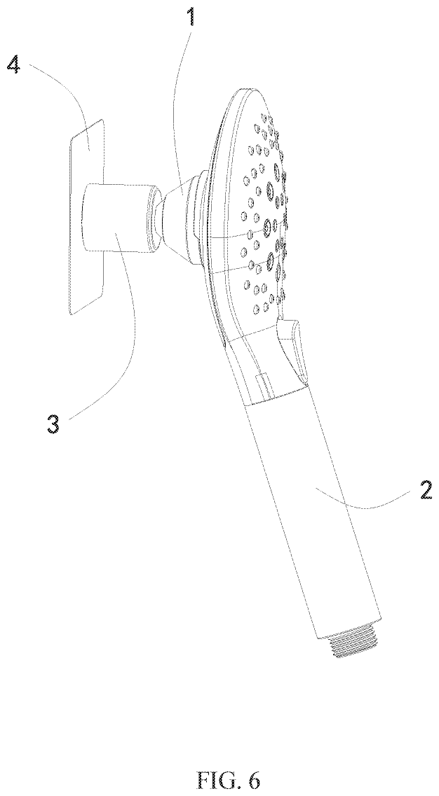

With reference to FIGS. 6-10, in the second embodiment, a first connection position is disposed at an end of the connection rod 3 away from the ball body 33, a second connection position is convexly disposed at an end of the cover body 4 close to the connection rod 3, and the first connection position and the second connection position are fixedly connected such that the connection rod 3 and the cover body 4 are connected. In this embodiment, the first connection portion is disposed as inner thread and the second connection position is disposed as outer thread. The inner thread and the outer thread are thread-connected such that the connection rod 3 and the cover body 4 are fixedly connected. An end of the cover body 4 away from the second connection position is disposed as a plane such that the cover body 4 is fixedly bonded on the wall by applying adhesive on the plane.

In the present utility model, the first magnetic attracting portion 11 and the second magnetic attracting portion 21 each having different magnetic poles are disposed on the hanging seat 1 and the shower head 2, respectively, such that the shower head 2 can be quickly hung on the hanging seat 1 through mutual attraction of the two magnetic attracting portions, resulting in convenience and simple operation. The ball body 33 is disposed on the connection rod 3 connected with the hanging seat 1 and the ball-shaped cavity is disposed on the hanging seat 1, such that the ball body 33 is capable of swinging freely and arbitrarily in the ball-shaped cavity to enable the shower head 2 to swing arbitrarily along the hanging seat 1. The water flowing channel and the water flowing opening 32 are disposed on the connection rod 3 such that the connection rod 3 can supply water and fixedly connect to the hanging seat 1 at the same time, thereby reducing the number of parts and thus lowering costs. The cover body 4 connected with the connection rod 3 is disposed as a plane such that the cover body 4 may be directly bonded to a wall through adhesive, thereby enabling simple and convenient mounting.

The preferred embodiments of the present utility model are illustrated and described as above. As mentioned above, it should be understood that the present utility model is not limited to the embodiments of the present utility model and the embodiments shall not be regarded as precluding other embodiments but may be used in other combinations, modifications and environments and also may be modified according to the above teachings or technologies or knowledge of relevant fields without departing from the scope contemplated in the present utility model. All modifications and changes made by those skilled in the art without departing from the spirit and scope of the present utility model shall all fall within the scope of protection of the claims of the present utility model.

1. A shower head hanger, comprising a hanging seat and a connection rod connected with one end of the hanging seat, a shower head being hung on the other end of the hanging seat, and the connection rod being disposed on a wall to enable the shower head to be disposed on the wall along with the hanging seat, wherein a first magnetic attracting portion is disposed at an end of the hanging seat close to the shower head, a second magnetic attracting portion corresponding to the first attracting portion is disposed inside the shower head, and the first magnetic attracting portion and the second magnetic attracting portion are magnetically attracted with each other such that the shower head is hung on the hanging seat.

2. The shower head hanger of claim 1, wherein the first magnetic attracting portion and the second magnetic attracting portion have different magnetic poles.

3. The shower head hanger of claim 1, wherein a magnet is disposed inside the first magnetic attracting portion, an iron piece is disposed inside the second magnetic attracting portion, and the magnet and the iron piece are attracted with each other such that the first magnetic attracting portion and the second magnetic attracting portion are attracted with each other.

4. The shower head hanger of claim 1, wherein an iron piece is disposed inside the first magnetic attracting portion, a magnet is disposed inside the second magnetic attracting portion, and the iron piece and the magnet are attracted with each other such that the first magnetic attracting portion and the second magnetic attracting portion are attracted with each other.

5. The shower head hanger according to claim 2, wherein a first magnetic attracting cavity is disposed at an end of the hanging seat close to the shower head, a second magnetic attracting cavity is disposed at a side of a body of the shower head away from a water spraying cover of the shower head, and the first magnetic attracting portion and the second magnetic attracting portion are received in the first magnetic attracting cavity and the second magnetic attracting cavity respectively such that the first magnetic attracting portion and the second magnetic attracting portion are magnetically attracted with each other.

6. The shower head hanger of claim 5, wherein surfaces of mutually-attached sides of the first magnetic attracting portion and the second magnetic attracting portion are provided with a rubber portion, the rubber portions fully cover the surfaces of the first magnetic attracting portion and the second magnetic attracting portion respectively or at least one through hole is opened in the rubber portions such that the first magnetic attracting portion and the second magnetic attracting portion are attracted with each other through exposure of the through holes.

7. The shower head hanger of claim 6, wherein a ball-shaped cavity is disposed at an end of the hanging seat away from the first magnetic attracting portion, a ball body is disposed at an end of the connection rod close to the hanging seat, and the ball body is received in the ball-shaped cavity such that the hanging seat is capable of swinging arbitrarily around the ball body.

8. The shower head hanger of claim 7, wherein the connection rod has a water flowing channel, an end of the connection rod close to the hanging seat is connected with a connection piece, a water flowing opening in communication with the water flowing channel is opened on the connection piece, the ball body is disposed at an end of the connection piece close to the hanging seat, and the ball body and the water flowing channel are isolated apart.

9. The shower head hanger of claim 7, wherein a first connection position is disposed at an end of the connection rod away from the ball body, a second connection position is convexly disposed at an end of a cover body close to the connection rod, and the first connection position and the second connection position are fixedly connected such that the connection rod and the cover body are connected.

10. The shower head hanger of claim 8, further comprising the cover body, wherein the cover body is sleeved on the connection rod and connected to a wall through the connection rod, or fixedly connected with the connection rod and bonded to the wall.

11. The shower head hanger according to claim 3, wherein the magnet is disposed inside the first magnetic attracting portion, the iron piece is disposed inside the second magnetic attracting portion, and the magnet and the iron piece are attracted with each other such that the first magnetic attracting portion and the second magnetic attracting portion are attracted with each other.

12. The shower head hanger according to claim 4, wherein the iron piece is disposed inside the first magnetic attracting portion, the magnet is disposed inside the second magnetic attracting portion, and the iron piece and the magnet are attracted with each other such that the first magnetic attracting portion and the second magnetic attracting portion are attracted with each other.

13. The shower head hanger of claim 9, further comprising the cover body, wherein the cover body is sleeved on the connection rod and connected to a wall through the connection rod, or fixedly connected with the connection rod and bonded to the wall.
